(19) United States
(12) Patent Application Publication
(10) Pub. No.: US 2021/0012060 A1
(43) Pub. Date: Jan. 14, 2021

(54) STRUCTURED DOCUMENT CONVERSION AND DISPLAY SYSTEM AND METHOD

(71) Applicant: INTELLEDOX PTY LTD, Fyshwick, Australian Capital Territory (AU)

(72) Inventors: Phillip WILLIAMSON, Deakin, Australian Capital Territory (AU); Christopher GABRIEL, Theodore, Australian Capital Territory (AU)

(21) Appl. No.: 16/969,899

(22) PCT Filed: Feb. 14, 2019
(86) PCT No.: PCT/AU2019/050114

§ 371 Date: Aug. 13, 2020

(30) Foreign Application Priority Data
Feb. 14, 2018 (AU) 2018900460

(51) Int. Cl. G06F 40/16; G06F 16/93; G06N 20/00; G06N 5/04; G06F 40/143; G06F 40/154; G06F 40/174; G06K 9/00; G06F 40/205

(52) U.S. Cl. CPC G06F 40/16; G06F 16/93; G06N 20/00; G06N 5/04; G06F 40/205; G06F 40/154; G06F 40/174; G06K 9/00449; G06F 40/143

(57) ABSTRACT

A method of translating a structured document into a dynamic interactive document having fillable fields, the method including the steps of: (a) inputting the structured document into a computer resource; (b) initially utilising the parsable structure of the structured document to determine input fillable fields in the structured document; and (c) outputting a second structured document including a series of interactive fillable fields corresponding to the determined input fillable fields.

### FIELD OF THE INVENTION

The present invention provides for systems and methods for the automated conversion of structured documents.

### BACKGROUND OF THE INVENTION

Any discussion of the background art throughout the specification should in no way be considered as an admission that such art is widely known or forms part of common general knowledge in the field.

Many different document formats have been extensively used in the Internet. For example, the Adobe Portable Document Format (PDF) has become hugely prevalent internationally for providing digital documents and forms across all sectors, including Government, education, business and also in the consumer world.

Many businesses have developed over the years a large set of forms to interact between their business processes and their customers, employees, service providers etc.

Historically, this proved to be a great step up away from paper based forms and manual processes, but as these organisations are now wanting to provide more modern, adaptive and contextualised interactions the challenge is now how to move all those old PDF-based forms to a modern user experience platform for interactive input of data.

One such platform is Intelledox Infiniti

It would be desirable for a system and method for automatic transfer of PDF documents or the like to an interactive input form of data.

### SUMMARY OF THE INVENTION

It is an object of the invention, in its preferred form to provide a system and method for the automated conversion of structured documents for the entry of data.

In accordance with a first aspect of the present invention, there is provided a method of translating a structured document into a dynamic interactive document having fillable fields, the method including the steps of: (a) inputting the structured document into a computer resource; (b) initially utilising the parsable structure of the structured document to determine input fillable fields in the structured document; and (c) outputting a second structured document including a series of interactive fillable fields corresponding to the determined input fillable fields.

In some embodiments, the method can further include the steps of: rendering the structured document into a corresponding visually displayable version of the structured document; utilising a computer vision subsystem to determine corresponding text fields in the visually displayable version; and utilising a machine language learning program to determine whether the text fields are preferably user enterable fields;

In some embodiments, structured document can be defined in the Portable Document Format (PDF). In some embodiments, the structured document can be defined in an eXtensible Markup Language (XML) format.

In some embodiments the method can further include the step of: providing an interactive user interface for a user to review the determination of input fillable fields. The step (b) further preferably can include: utilizing machine learning on a series of historical document examples to determine probabilistically if a document has input fillable fields. In some embodiments, upon completion of the creation of the second structured document, the second structured document can be added to the series of historical document examples.

In some embodiments, when the structured document includes non fillable forms, the step (b) preferably can include rendering the structured document into a corresponding image, utilizing optical character recognition to determine corresponding textual information, and applying machine learning techniques to the textual information to determine corresponding input fillable fields in the PDF structured document.

In accordance with another aspect of the present invention, there is provided a system for translating a structured document into a dynamic interactive document having fillable fields, the system including; first input means for inputting a structured document description to a computer processing means; computer means for analyzing the structured document description to determine fillable fields located therein; and to generate a second structured document including a series of interactive fillable fields corresponding to the input fillable fields.

### BRIEF DESCRIPTION OF THE DRAWINGS

Embodiments of the invention will now be described, by way of example only, with reference to the accompanying drawings in which:

FIG. 1 illustrates schematically the system environment of the preferred embodiment;

FIG. 2 is a flow chart of the steps of an embodiment;

FIG. 3 illustrates a resulting interactive form for review by a user.

### DETAILED DESCRIPTION

The embodiments of the invention provide a web based interactive processing system that intelligently analyses a PDF structure and, using a machine learning model, constructs a dynamic modern user experience removing the need to manually reproduce the experience.

In one embodiment, it is designed to handle conversion of: 1) Fillable PDF forms, by reading the pre-existing fillable field definitions within the PDF format. 2) Non-fillable PDF forms, which are characterised by needing to be printed to fill in the spaces provided, by using computer vision technology and machine learning to match common form patterns and extract contents of each field.

The embodiments dramatically reduce the effort to create mobile first, dynamic user experiences based on an existing user PDF and a library of existing PDF forms. Large forms can be time consuming to create manually, field by field. By converting an existing form and capturing all the fields, the form creation process can be significantly faster and allow the form designer to focus on adding adaptive logic and other smart form features to deliver dramatic user experience improvements.

The embodiments process, read and interpret any existing PDF fillable form fields from the underlying PDF structure. Identifying and interpreting field names, types and relationships between fields.

For non-fillable PDF forms, the systems converts each page into its corresponding image, and leverages existing computer vision technology to find potential form fields visually. This process uses machine learning based on example tagged PDF forms to learn visual patterns to break up fields successfully.

Both paths through the system result in a map of possible field names, data types and field relationships to represent the input PDF. This map can be passed into a machine learning algorithm to interpret intent to find the best possible match to dynamic user experience question types, such as date pickers, text fields, checkboxes and radio buttons.

The user is presented with this map and an opportunity to modify what the system has determined programmatically. The resulting map is simultaneously sent back to the machine learning algorithm as additional inputs for future system cycles as well as to a generation engine that processes the map into an adaptive user experience.

The embodiments are initially designed to run on a computer networked environment and include a number of separate components.

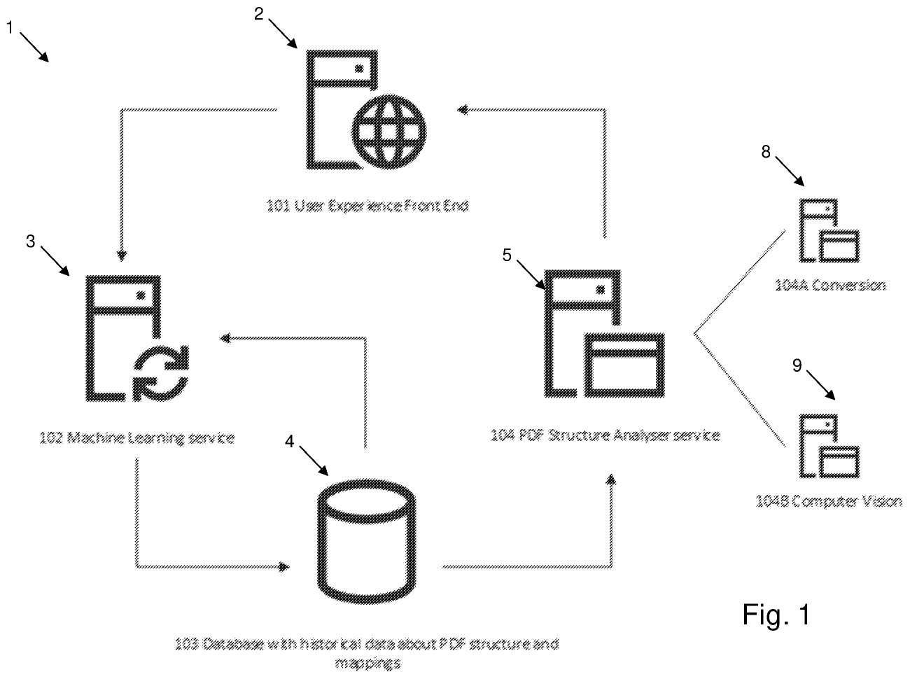

Turning initially to FIG. 1, there is illustrated one form of system architecture for one embodiment. The system is comprised of four distinct components 2-5 as depicted in FIG. 1.

These include: A User Experience Front End 2. This is the delivery mechanism to a user's web browser. The portion of the embodiment output and displays HTML to the browser or populating a dynamic end user system display (such as Intelledox Infiniti) In the latter case, this would involve the generation of XML input required for consumption by a display system.

Machine Learning service 3. Guided by a large and continuing growing database of previous matches (4) the machine learning service 3 takes the structure of the uploaded PDF and attempts to match the naming, data type and field relationships of the document. The model learns further from inputs from user experience front end 2, where the user has updated or modified the mapping.

A Database 4 with historical data about PDF structure and mappings. This database can forms the input for a machine learning algorithm to determine the possible name, data type and relationship to other fields that exists for the input PDF. This database grows in proportion to the number of mappings performed by the embodiment, thereby growing more accurate over time.

PDF Structure analyser service 5. This service is a combination of technologies that breakdown the structure of a PDF document which is then used as inputs to the machine learning service 3 and the basis for the end user experience. This service rebuilds the structure of the PDF into an XML form that describes it's structure and fields for consumption by the User Experience Front End (2).

The PDF structure analyser service includes two subsystems, including a Conversion subsystem 8 and a Computer vision subsystem 9.

The embodiments include both a user interface component and a server side processing component.

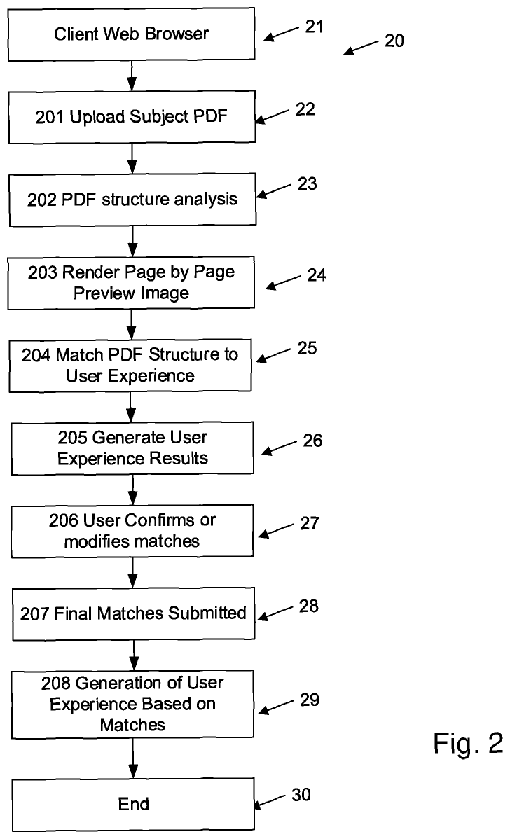

Turning now to FIG. 2, there is illustrated a flow chart 20 of steps involved in a user interaction and associated system tasks. Each of these steps is described in more detail below:

A user can initially interact via a web browser 21 to upload at least one (or a series) of PDF files 22. To use this technology users are guided through a series of steps, using a web based user experience.

The embodiments handle both single and multiple PDF file uploads within the stage 22. For clarity, the discussion flow focuses on the singular but the plural is applicable in all cases. At the stage 22, the source PDF file is identified and loaded by the system, so that it can be analysed for its content and structure. This is executed by the system component 2 of FIG. 1.

PDF file structure analysis 23. This step is performed by the PDF structure analyser (5 of FIG. 1). The conversion subsystem parses the PDF file to detect fields/questions, as well as form input structures and data types.

Render Page by Page Preview image 24. To assist the user experience and as input to the computer vision subsystem (9 of FIG. 1) the system component renders an image format representation of each page of the input. If the PDF structure analysis is not complete, the images will be processed by the computer vision subsystem (9 of FIG. 1) to further analyse the structure and field relationships of the input.

This process uses a number of methods to detect fields in the form, including the ability to parse the PDF fields from fillable forms as well as using computer vision to visually detect fields, and to use system learned best matches to question text, intent and type of information being captured.

Match PDF Structure to User Experience 25. The raw PDF structure of fields and their position are sent to the machine learning service (3 of FIG. 1) to draw on historical data for like fields and usage. The service determines how to name the field and possible user interface data type. For example, Date of Birth would be detected with high confidence of being a Date and is matched to the Date user interface data type. Further relationships are made with surrounding fields on the form which may result in the algorithm returning a single datatype for many fields. For example, the detection of the text field named Address 1 in close proximity on the PDF to Address 2, City or State may return a high confidence that all of those fields can be represented by a single field named Address which is a compound user interface data type of Address. This intelligent resolution capability simplifies the review process and allows the generation in stage 27 to be a highly dynamic user experience.

Generate User Experience Results 26: The resulting structure from step 25 is converted to a user experience for the user to visualize what has been detected.

User confirms or modifies matches 27: The machine learning algorithm ranks it's results and provides the user with the best guesses based on the history contained in the database (4 of FIG. 1). The user is presented with a preview window showing the PDF file as an image marked-up with the various discovered fields.

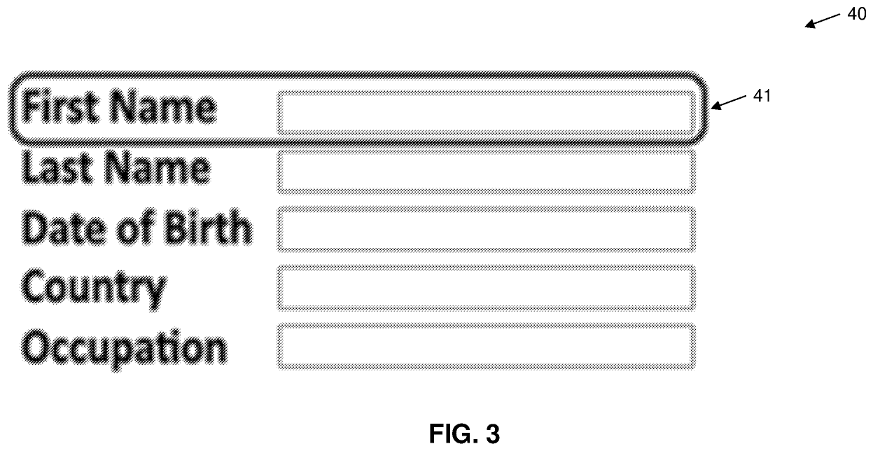

An example of the presentation is as illustrated 40 in FIG. 3, wherein the user is shown various fields and ask to confirm the details associated with the field.

This stage of the process allows the user to override the field names detected by the system, re-order the questions or override the various system-detected elements such as field type.

Final matches submitted 28: The overridden selections (and system generated selections) are sent to the machine learning service (3 of FIG. 1) to train future conversions, populating a history database (4 of FIG. 1) which will improve results and accuracy over time.

Generation of User Experience based on matches and selections: 29. With all the information collected the system now has enough information to construct a new user experience or input based on the PDF, taking into account all the field matches and overrides provided by the user. To do this the system creates a form in a native import format, such as an XML definition of the form's structure.

It can therefore be seen that the preferred embodiment provides a system and method for the automated translation of PDF documents or the like into a subsequent format, which allows for the intelligent entry of information into fields.

### Interpretation

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A method of translating a structured electronic document into a dynamic interactive document having fillable fields, the method including the steps of:
(a) inputting the structured document into a computer resource;
(b) initially utilising the parsable structure of the structured document to determine input fillable fields in the structured document; and
(c) outputting a second structured document including a series of interactive fillable fields corresponding to the determined input fillable fields.

2. A method as claimed in claim 1 further comprising the steps of:
rendering the structured document into a corresponding visually displayable version of the structured document;
utilising a computer vision subsystem to determine corresponding text fields in the visually displayable version; and
utilising a machine language learning program to determine whether the text fields are user enterable fields.

3. A method as claimed in claim 2 wherein the structured document is defined in the Portable Document Format (PDF).

4. A method as claimed in claim 1 wherein the structured document is defined in an eXtensible Markup Language (XML) format.

5. A method as claimed in claim 1 further comprising the step of:
providing an interactive user interface for a user to review the determination of input fillable fields.

6. A method as claimed in claim 1 wherein said step (b) further includes:
utilizing machine learning on a series of historical document examples to determine probabilistically if a document has input fillable fields.

7. A method as claimed in claim 2 wherein, upon completion of the creation of said second structured document, the second structured document is added to a database of the series of historical document examples.

8. A method as claimed in claim 1 wherein, when said structured document includes non fillable forms, said step (b) includes rendering the structured document into a corresponding image, utilizing optical character recognition to determine corresponding textual information, and applying machine learning techniques to said textual information to determine corresponding input fillable fields in said PDF structured document.

9. A system for translating a structured document into a dynamic interactive document having fillable fields, the system including:
first input means for inputting a structured document description to a computer processing means;
computer processing means for analyzing the structured document description to determine fillable fields located therein; and to generate a second structured document including a series of interactive fillable fields corresponding to the input fillable fields.
